(19) United States
(12) Patent Application Publication
(10) Pub. No.: US 2011/0029633 A1
(43) Pub. Date: Feb. 3, 2011

(54) SERVER DEVICE AND METHOD FOR REMOTE CONTROLLING THE SAME

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/558,590

(22) Filed: Sep. 14, 2009

(30) Foreign Application Priority Data
Jul. 29, 2009 (TW) 98125584

(51) Int. Cl. G06F 15/16

(52) U.S. Cl. 709/209; 709/219

(57) ABSTRACT

A server device and a method for remote controlling the server device and the server device are provided. The server device includes a plurality of nodes which are electrically connected to each other. In the method for remote controlling the server device, each of the nodes is first set to a common mode. When a first node among the nodes is logged in by a remote end, the first node enters a master mode from the common mode, and a plurality of second nodes among the rest of the nodes are notified to enter a slave mode from the common mode and can only be controlled by the first node, and then, the first node collects data of all of the nodes.

### RELATED APPLICATIONS

This application claims priority to Taiwan Application Serial Number 98125584, filed Jul. 29, 2009, which is herein incorporated by reference.

### BACKGROUND

1. Field of Invention

The present invention relates to a method for controlling a server device. More particularly, the present invention relates to a method for remote controlling a server device.

2. Description of Related Art

A conventional high-density server includes a back panel, an enclosure management unit and a plurality of independently-operated motherboards, wherein the enclosure management unit is disposed on the back panel, and the motherboards are inserted on the back panel respectively and are electrically connected to the enclosure management unit. The enclosure management unit is used to administer the respective motherboards. When a remote end (computer) is desired to administer or configure one of the motherboards and connected to the high-density server, the enclosure management unit will request the one of the motherboards to deliver the corresponding data to the remote end in accordance with the requirement of the remote end.

In order to lower the hardware cost of the conventional high-density server, the enclosure management unit is removed therefrom so as to design another conventional high-density server without the enclosure management unit.

However, since this conventional high-density server does not have the enclosure management unit, when a remote end (computer) is connected to this conventional high-density server to administer or configure one of the motherboards thereof, the remote end has to individually connect to the one of the motherboards thereof desired to be handled, thus causing quite a lot of inconvenience and time consumption.

Hence, it is an important topic for those in this industry to develop a method for remote controlling a server device for effectively improving the aforementioned shortcomings by not only lowering the hardware cost but also remote administering any one of the motherboards for preventing inconvenience and time consumption.

### SUMMARY

In view of the aforementioned shortcomings, an aspect of the present invention is to provide a method for remote controlling a server device, thereby lowering the material cost of the server device by removing an enclosure management unit from the server device.

Another aspect of the present invention is to provide a method for remote controlling a server device for assigning one node of the server device to play the role of the enclosure management unit, so that a remote end does not need to connect to the node desired to be handled individually, thus promoting administration quality and saving handling time.

In accordance with the aforementioned aspects, a method for controlling a server device is provided, wherein the sever device includes a plurality of nodes which are electrically connected to each other. The method includes the steps of: setting each of the nodes to a common mode; and when a first node among the nodes is logged in by a remote end, the method further includes the steps of: enabling the first node to enter a master mode from the common mode; notifying a plurality of second nodes among the rest of the nodes to enter a slave mode from the common mode, wherein the second nodes can only be controlled by the first node; and enabling the first node to collect data of all of the nodes.

In one embodiment, the method further includes the step of enabling the first node to return the data of one of the nodes to the remote end, when the remote end issues a data request instruction.

In another embodiment, the method further includes the step of enabling the first node to control at least one of the second nodes to perform a reboot procedure in accordance with an instruction of the remote end, when the remote end issues the instruction of performing the reboot procedure.

In another embodiment, the method further includes the step of enabling the first node to enter the common mode from the master mode, and notifying all of the second nodes to enter the common mode from the slave mode, when the remote end logs out of the first node.

In the embodiments, when entering the common mode, the master mode or the slave mode, each of the nodes records a flag code representing a current mode of each of the nodes.

In another aspect, the sever device includes a housing and a plurality of nodes. The housing has a back panel, and the back panel has an inter-integrated circuit (I2C) bus. The nodes are pluggable into the back panel, and are electrically connected to each other via the I2C bus. Thus, when one of the nodes is logged in by a remote end, the one of the nodes enter a master mode, and the rest of the nodes enter a slave mode and can only be controlled by the node which is at the master mode.

In one embodiment, the nodes have the same specification.

In another embodiment, the server device is a high-density server or a blade server.

To sum up, the embodiments of the present invention do not need to add the hardware of enclosure management unit, thus lowering hardware cost; and overcome the inconvenience and bothers caused by not having the enclosure management unit, thus promoting administration quality and saving handling time.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic block diagram showing a server device according to an embodiment of the present invention; and

FIG. 2 is a schematic flow chart showing a method for controlling the server device according to the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a server device and a method for controlling the server device, wherein one of the nodes in the server device is assigned to replace the role of an enclosure management unit, so that a remote end may configure and administer other nodes via the node assigned, and thereby the remote end does not need to establish an individual connection to the node desired to be handles, thus promoting administration quality and saving handling time.

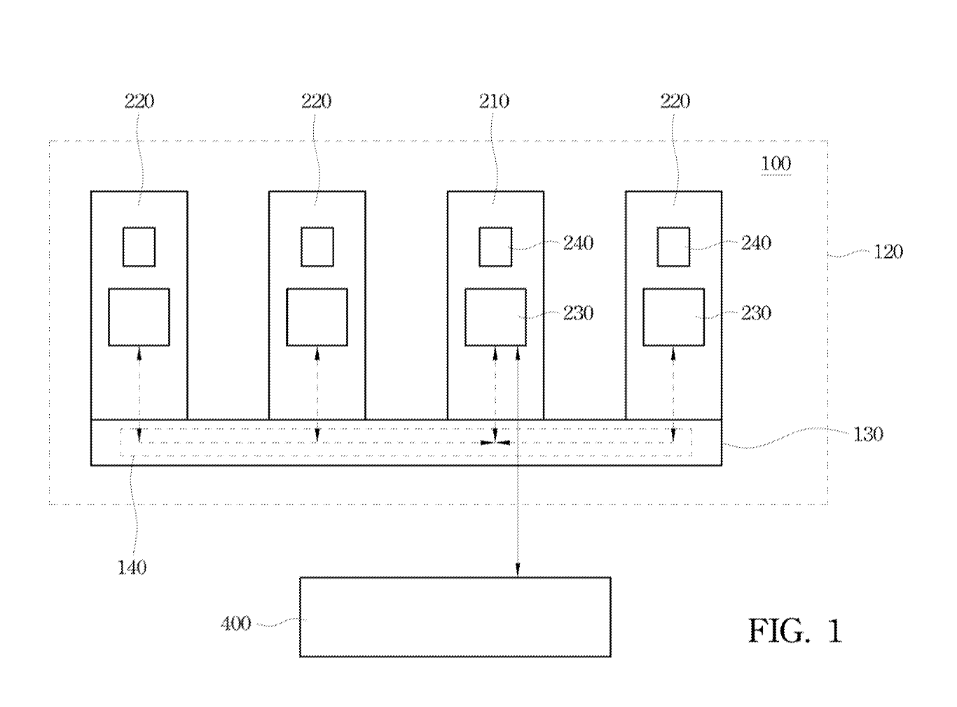

Referring to FIG. 1, FIG. 1 is a schematic block diagram showing a server device according to an embodiment of the present invention. In this embodiment, the server device 100, such as a high-density server or a blade server, includes a housing 120 and a plurality of nodes 210 and 220 as shown in FIG. 1. The housing 120 has a back panel 130, and the back panel 130 has an inter-integrated circuit (I2C) bus 140. Each of the nodes 210 and 220 has a base board management controller (BMC) chip 230, and are pluggable into the back panel 130 in a parallel arrangement. The nodes 210 and 220 can be the computer products with the same specification, such as the motherboards with the same specification. The BMC chip 230s of the nodded 210 and 220 can be eclectically connected to each other via the I2C bus 140, and can communicate with each other via an intelligent platform management bus (IPMB). The server device 100 may allow a remote end 400 to log into one node (such as the node 210 of FIG. 1) of the server device 100 via an interface of WEB, Telnet or Secure Shell.

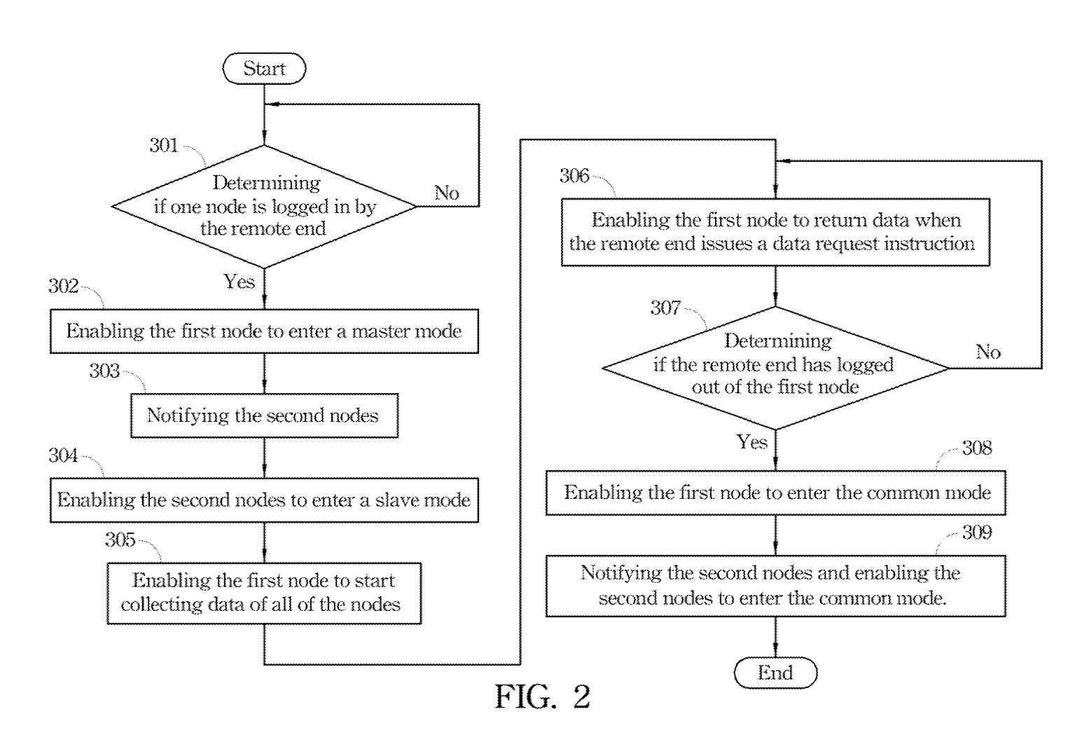

Before the server device 100 is logged in by the remote end 400, the current mode of each of the nodes 210 and 220 is a common node. After the server device 100 is logged in by the remote end 400, the node (such as the node 210 of FIG. 1) logged in by the remote end 400 leaves the common mode. Since the nodes 210 and 220 all have the chances to be logged in by the remote end 400, the node logged in by the remote end 400 is referred as “a first node 210” and the rest of the nodes are referred to as “second nodes 220” hereinafter for avoiding confusion. However, it does not mean that the first node 210 and the second nodes 220 are the units with different specifications. In the below, a method for remote controlling the server device is disclosed. Referring to FIG. 1 and FIG. 2, FIG. 2 is a schematic flow chart showing a method for controlling the server device according to the embodiment of the present invention. The method is performed in accordance with the following steps.

Step 301 is performed to determine if one of the nodes 210 and 220 is logged in by the remote end 400. When the result is yes, step 302 is performed, or the method returns to step 301.

Step 302 is performed to enable the first node 210 to enter a master mode. When the BMC chip 230 of the first node 210 detects and learns that the remote end 400 has logged in, the BMC chip 230 switches the current mode of the first node 210 to the master mode, and records a flag code 240 representing the master mode.

Then, step 303 is performed to notify the second nodes 220. In this step, the BMC chip 230 of the first node 210 issues a message indicating that “the first node 210 has entered the master mode”, such as an identification number of the first node 210 and its flag code 240, to the second nodes 220.

Thereafter, step 304 is performed to enable the second nodes 220 to enter a slave mode. In this step, after all of the second nodes receive the aforementioned message, the BMC chips 230 of the second nodes 220 switch their respective nodes to the slave mode from the common mode. It is noted that, after entering the slave model, all of the second nodes 220 can only be controlled by the first node 210. In other words, the second nodes 220 shut down their respective administration interfaces, and temporarily disable the administering functions of their respective BMC chips, and thus merely accept the instructions from the first node 210.

Then, step 305 is performed to enable the first node 210 to start collecting data of all of the nodes. In this step, the first node 210 requests all of the nodes (including the first node 210 and all of the second nodes 220) to start collecting data via the I2C bus 140, and then all of the nodes 220 transmit the collected data to the first node 210 via the I2C bus 140.

The collected data are not limited to system environment messages (such as sensor statuses), event logs or other configuration data.

Step 306 is performed to enable the first node 210 to return the data to the remote end 400 when the remote end 400 issues a data request instruction. After the remote end 400 issues the data request instruction, the first node 210 returns to the remote end 400 the data corresponding to the first node or/end the second nodes 220 indicated by the data request instruction, so that the remote end may base on the data to perform administration.

Further, in another embodiment, when the remote end 400 issues an instruction of performing a reboot procedure, the first node 210 controls at least one of the second nodes 220 indicated by the instruction to perform the reboot procedure or a shutdown procedure.

Thereafter, step 307 is performed to determine if the remote end 400 has logged out of the first node 310. If the result is yes, step 308 is performed, or the method returns to step 306.

Step 308 is performed to enable the first node 210 to enter the common mode. When the BMC chip 230 of the first node 210 detects and learns that the remote end 400 has logged out of the first node 310, the BMC chip 230 switches the current mode of f the first node 210 to the common mode from the master mode, and records a flag code 240 representing the common mode.

Then, step 309 is performed to notify the second nodes 230 and enable the second nodes 230 to enter the common mode. In this step, the BMC chip 230 of the first node 210 issues a message indicating that “the first node 210 has left the master mode”, to all of the second nodes 220, wherein the BMC chip 230 records a flag code 240 representing the common mode.

To sum up, the embodiments of the present invention have the advantages of lowering hardware cost by not needing to add the hardware of enclosure management unit; and overcoming the inconvenience and bothers caused by not having the enclosure management unit, thus promoting administration quality and saving handling time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for remote controlling a server device, wherein the sever device comprises a plurality of nodes which are electrically connected to each other, the method comprising:
setting each of the nodes to a common mode, wherein when a first node among the nodes is logged in by a remote end, the method further comprises:
enabling the first node to enter a master mode from the common mode;
notifying a plurality of second nodes among the rest of the nodes to enter a slave mode from the common mode, wherein the second nodes can only be controlled by the first node; and
enabling the first node to collect data of all of the nodes.

2. The method as claimed in claim 1, further comprising:
when the remote end issues a data request instruction, enabling the first node to return the data of one of the nodes to the remote end.

3. The method as claimed in claim 1, further comprising:
when the remote end issues an instruction of performing a reboot procedure, enabling the first node to control one of the second nodes to perform the reboot procedure in accordance with the instruction of the remote end.

4. The method as claimed in claim 1, further comprising:
when the remote end logs out of the first node, enabling the first node to enter the common mode from the master mode, and notifying all of the second nodes to enter the common mode from the slave mode.

5. The method as claimed in claim 4, wherein, when entering the common mode, the master mode or the slave mode, each of the nodes records a flag code representing a current mode of each of the nodes.

6. The method as claimed in claim 1, wherein the nodes are electrically connected to each other via an inter-integrated circuit (I2C) bus.

7. A server device, comprising:
a housing having a back panel, the back panel having an inter-integrated circuit (I2C) bus; and
a plurality of nodes which are pluggable into the back panel and are electrically connected to each other via the I2C bus, wherein, when one of the nodes is logged in by a remote end, the one of the nodes enter a master mode, and the rest of the nodes enter a slave mode and can only be controlled by the one of the nodes.

8. The server device as claimed in claim 7, wherein the nodes have the same specification.

9. The server device as claimed in claim 7, wherein the server device is a high-density server.

10. The server device as claimed in claim 7, wherein the server device is a blade server.
